(19) United States
(12) Patent Application Publication
(10) Pub. No.: US 2008/0235285 A1
(43) Pub. Date: Sep. 25, 2008

(54) Instant Messaging Service with Categorization of Emotion Icons

(75) Inventor: Roberto Della Pasqua, Savignano sul Rubicone (IT)

Correspondence Address: YOUNG & THOMPSON, 209 Madison Street, Suite 500, ALEXANDRIA, VA, 22314, US

(73) Assignee: Roberto Della Pasqua, S.R.L., Savignano Sul Rubicone (IT)

(21) Appl. No.: 12/088,086

(22) PCT Filed: Sep. 26, 2006
(86) PCT No.: PCT/EP2006/066748

§ 371 Date: May 12, 2008

(30) Foreign Application Priority Data
Sep. 29, 2005 (IT) MI2005A001812

(51) Int. Cl. G06F 17/30

(52) U.S. Cl. 707/104.1; 707/E17.019

(57) ABSTRACT

A method for sending messages in a data processing system (100) includes the steps of: providing a plurality of emotion images (240) each one including a digital graphic representation of an emotional state, the emotion images being partitioned into a plurality of categories, providing a plurality of category images (230) each one including a digital graphic representation of an emotional category, displaying at least part of the category images (225), selecting one of the displayed category images (230s), displaying at least part of the emotion images associated with the selected category image (235), selecting one of the displayed emotion images (240s), and inserting the selected emotion image into a new message (215).

### TECHNICAL FIELD

The present invention relates to the data processing field. More specifically, the present invention relates to messaging services.

### BACKGROUND

The messaging services (such as the chats) are become increasingly popular, especially in the Internet; these services allow several users to exchange information of every kind in a direct and immediate manner. For this purpose, every user accesses—by means of his/her client computer (such as a PC)—a server that provides the chat service in the Internet. The user can then send messages to other users of the chat and display all the messages being inserted therein. Every message is composed by a text, generally including emotion icons (emoticons), which represent a specific emotional state of the user. The emotion icons can be inserted into the message by strings of alphanumeric characters, which are automatically converted into the corresponding graphic representations of the emotion icons. Moreover, in order to facilitate this operation the modern chats allow inserting the emotion icons directly in the message. For this purpose, there is provided a panel where the user can select the desired emotion icons (for example, by a mouse).

A problem of the above-described structures is due to the difficulty of managing the operation of inserting the emotion icons in the messages. Indeed, the widespread diffusion of the chats has involved an enormous proliferation of the emotion icons; moreover, a lot of custom emotion icons have been developed for the use in thematic chats. Therefore, the number of the emotion icons available for the user is higher and higher.

Accordingly, it is rather complicated and difficult for the user to spot the desired emotion icon every time (among the many ones displayed in the respective panel).

Moreover, the display of the emotion icons for their selection requires a relatively large memory space. In order to keep acceptable the memory occupation, the chats known in the art are consequently obliged to reduce the quantity of information used to represent every emotion icon (with a consequent deterioration of the display quality).

### SUMMARY

In its general terms, the present invention is aimed at facilitating the sending of the messages.

Particularly, the present invention provides a solution as set out in the independent claims. Advantageous embodiments of the invention are described in the dependent claims.

More specifically, an aspect of the invention provides a method for sending messages in a data processing system (for example, in a chat on the Internet). The method envisages providing a plurality of emotion images (or icons), each one including a digital graphic representation of an emotional state; the emotion images are partitioned into a plurality of categories. The method also envisages providing a plurality of category images (or icons), each one including a digital graphic representation of an emotional category. The category images (or a part of them) are displayed. A user can then select one of the displayed category images. In response thereto, the emotion images associated with the selected category image are displayed (completely or in part). At this point, the user can select one of the displayed emotion images. The selected emotion image is then inserted into a new message.

Another aspect of the invention proposes a computer program for performing the method.

A further aspect of the invention proposes a corresponding system.

### BRIEF DESCRIPTION OF THE DRAWINGS

The invention itself, however, as well as further features and the advantages thereof, will be best understood with reference to the following detailed description, given purely by way of a non-restrictive indication, to be read in conjunction with the accompanying drawings, in which:

FIG. 1 is a pictorial representation of a computer in which the solution according to an embodiment of the invention can be applied;

FIGS. 2a-2d, 3, 4a-4c e 5 show different working examples of the solution according to an embodiment of the invention; and

FIG. 6 shows the main software components that can be used to practice the solution according to an embodiment of the invention.

### DETAILED DESCRIPTION

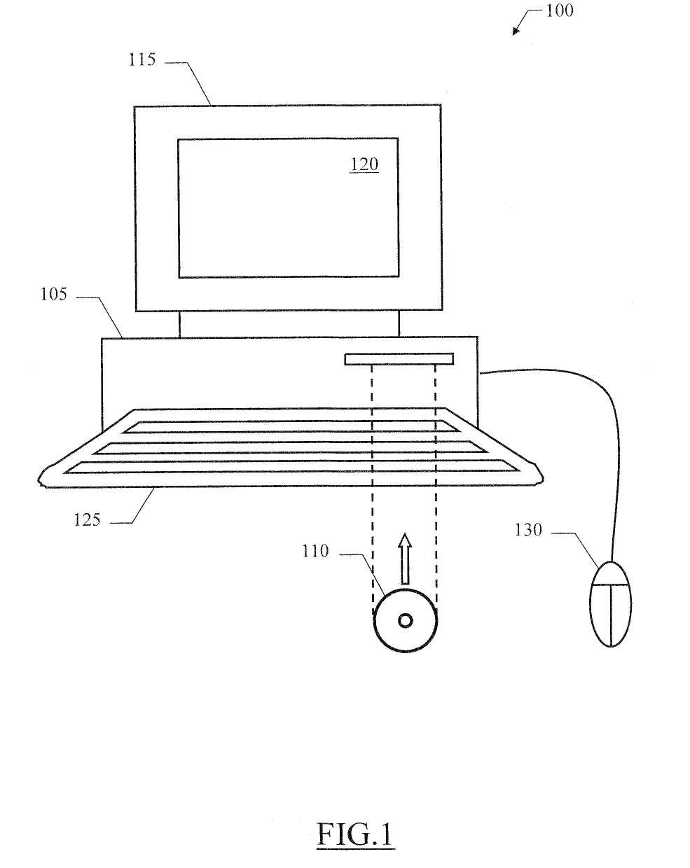

With reference in particular to FIG. 1, a computer 100 (for example, a PC) is illustrated. The computer 100 consists of a central unit 105, which houses the electronic circuits controlling its operation (such as a microprocessor and a working memory). The computer 100 is also provided with a hard-disk and a drive for reading CD-ROMs 110. A monitor 115 is used to display images on a screen 120. Operation of the computer 100 is controlled by means of a keyboard 125 and a mouse 130, which are connected to the central unit 105 in a conventional manner.

The central unit 105 also houses a MoDem (for example, of the ADSL type); the MoDem is used to access the Internet (through a suitable access provider). In this way, the computer 100 operates as a client, which can exploit shared resources supported by different servers in the Internet; particularly, a user of the computer 100 can connect to a real-time discussion (chat) managed by a specific server (or more).

The chat consists in a service that allows many users to exchange messages. Every user can then send information of different types to the server, which information is immediately replied on the computers of the other users. Generally, the chat supports multiple sessions, known as chat rooms, each one managed by a dedicated communication channel.

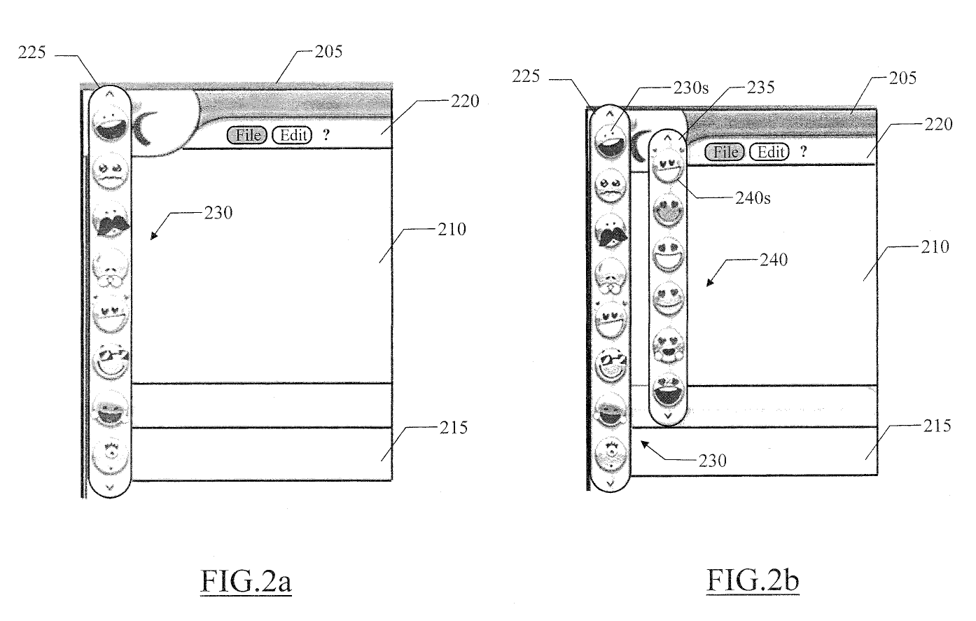

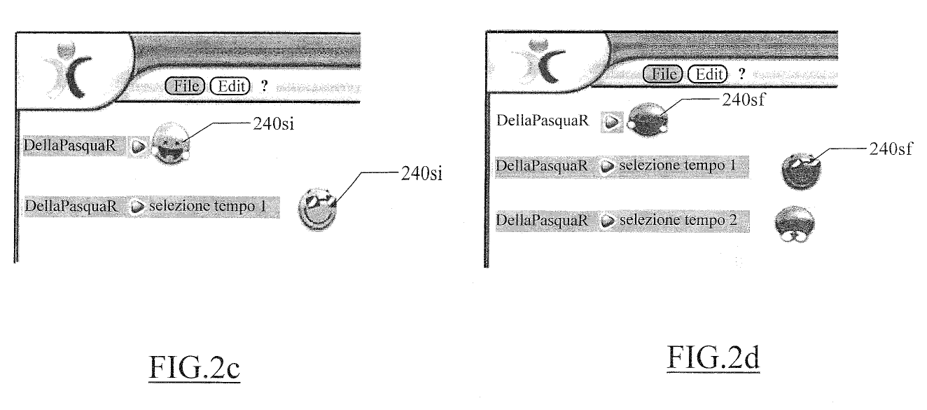

Passing now to FIG. 2a, every room involves the display of a window 205 on the screen of the computer. The window 205 is partitioned into different frames; particularly, an output frame 210 scrolls the messages inserted in the room by all the users, whereas an input frame 215 is used by the user of the computer to insert new messages. Moreover, the window 205 is provided with a command bar 220, by which it is possible to invoke the different commands that are available to the user for managing the chat (for example, for filtering the messages, for saving them in a file, and the like). Every message is composed by a text; in general, in the text there are inserted different emotion icons (emoticons), also known as smiling faces (smiley). The word emoticon comes from the contraction of the words emotion and icon; in fact, these objects are icons (i.e., small images representing a concept graphically), which in the specific case show an emotion (i.e., a mental condition of the interested people).

The emotion icons can be inserted (in the input frame 215) by a predefined string of alphanumeric characters, which is generally interpreted from the left to the right. For example, the alphanumeric string “:)” represents a smile, the string “:D” represents a laugh, and so on. Normally, the alphanumeric strings are automatically converted into the corresponding graphic representations (by an auto-composition function).

Moreover, most of the chats allow inserting the emotion icons into the messages in their graphic form directly.

For this purpose, in the solution according to an embodiment of the present invention, the emotion icons are partitioned into different categories. For example, it is possible to provide categories for happiness, sadness, love, fear, surprise and so on. To every category there is associated a corresponding icon, which provides a graphic representation thereof.

The window 205 is then provided with an icon-carrying panel 225 (arranged vertically along the right edge of the window 205); preferably, the panel 225 resizes automatically according to the window 205. This panel displays the category icons, denoted with 230, in a scroll list (which can be made to scroll forwards and backwards by two corresponding commands available at the ends of the panel 225).

The user selects a particular category icon 230 by simply stopping a pointer (the position of which is managed by the mouse) over it. For example, as shown in FIG. 2b, the user has selected the category icon of the fear (denoted with 230s). In response thereto, a new panel 235 is opened next to the selected category icon 230s. This panel displays the corresponding emotion icons, denoted with 240, in a similar scroll list. At this point, the user can select the desired emotion icon, like the emotion icon of the crying denoted with 240s (for example, by a double click of the left button of the mouse).

Consequently, the selected emotion icon 240s is inserted into the input frame 215 (in the current position of a cursor within the new message).

This solution facilitates the selection of the emotion icons. Moreover, this can reduce the number of the emotion icons that are displayed simultaneously. In this way, it is possible to increase the amount of information used to represent every emotion icon (for the same available memory space); this has a beneficial effect on the display quality of the emotion icons.

Preferably, the arrangement of the category icons 230 in the panel 225 changes dynamically according to their frequency of use. For example, the category icons 230 are arranged in decreasing order of frequency of use; in this way, the category icons 230 of common use will be placed at the top of the panel 225 (always visible and easily accessible), whereas only the category icons 230 being used more rarely may be hidden (requiring the upwards scroll command for their display). It is also possible to replace every category icon 230 being used recently (for example, in the last 30-90 seconds) with the last selected one of the corresponding emotion icons 240. This further facilitates the selection of the emotion icons 240, since it allows the direct access (i.e., without the respective category icon 230) to the ones of more common use.

With reference to FIGS. 2c-2d, the selected emotion icons are preferably highlighted by a shading algorithm (known as “Wheel HUE”). In particular, every emotion icon (for example, yellow) is displayed in a different colour when selected (for example, blue). Moreover, the colour of the selected emotion icon changes from a starting chromatic tonality to an ending chromatic tonality, and then comes back towards the starting chromatic tonality; this process is repeated continuously (such as every 1-5 seconds). For example, at first (FIG. 2c) the selected emotion icon, denoted with 240si, is light blue. The selected emotion icon 240si then passes gradually from light to dark; at the end of every half-period of the shading process (FIG. 2d), the selected emotion icon, denoted with 240sf, will become all blue (to return light blue in the next half-period, and so on). This feature allows obtaining an aesthetic effect very pleasant for the user; in particular, the achieved result is far better than the one provided by the standard XOR algorithms (where the colours of the selected objects are simply inverted).

As a further improvement, every category icon 230 is associated with a corresponding string of alphanumeric characters; this string is the same as the one used to insert the most representative of the corresponding emotion icons 240 (for example, the category icon 230 of the happiness is associated with the alphanumeric string “:)” of the emotion icon 240 of the smile).

Let us assume now that the user enters the alphanumeric string of an emotion icon 240 representative of its category in the input panel 215; this alphanumeric string is automatically converted into the corresponding graphic representation by the auto-composition function (as usual). However, if the user repeats the last character of the alphanumeric string, the emotion icon 240 is replaced with the next one in a predefined sequence (of all the emotion icons 240 of the category). Preferably, the sequence is defined dynamically according to a decreasing order of frequency of use of the emotion icons 240. The process is repeated at every repetition of the last character of the alphanumeric string (until returning to the emotion icon 240 representative of the category, so as to implement a wrap-around list). For example, by entering the character “:” followed by the character “)” the emotion icon 240 of the smile appears; by going on entering the character “)” this emotion icon 240 is replaced in rotation with all the others of the category of the happiness. On the contrary, if the last inserted alphanumeric character is deleted (by typing the key “<---”) the preceding emotion icon 240 in the sequence is restored.

The same result can be also achieved by maintaining pressed the key corresponding to the last character of the alphanumeric string. The emotion icon 240 is now replaced with the next one in the sequence at the expiration of every predefined period during which the key is maintained pressed (for example, every 1-3 seconds). In this case, it is also preferably available a restore command (for example, in the bar 220), which allows returning in succession to the preceding emotion icons 240.

In any case, the desired effect is preferably obtained by changing every emotion icon 240 into the next one gradually; for example, it is possible to warp the starting emotion icon 240, by moving its points towards the ones of the target emotion image 240 by a technique known as “morphing”.

The feature described above allows selecting the desired emotion icon 240 in the chosen category, without the need to open any further panel.

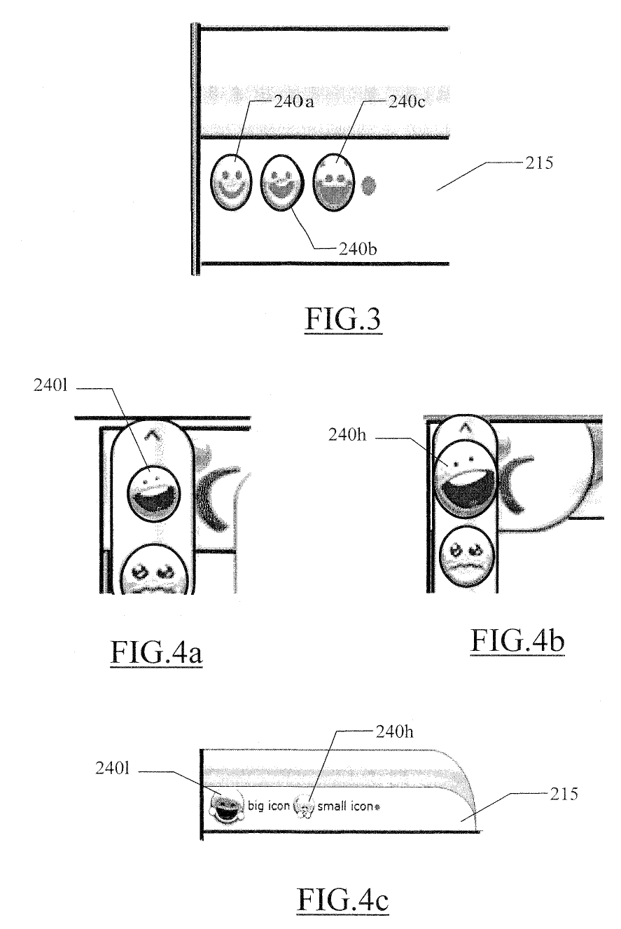

With reference now to FIG. 3, in alternative the emotion icons of each category can be grouped into one or more homogeneous sets; in every set, the emotion icons are ordered in a sequence of increasing intensity. For example, in the category of the happiness it is possible to have a set of smiles, with an emotion icon of a slight smile, an emotion icon of a more intense smile, and so on until an emotion icon of a high laugh.

In this case as well, every set is associated with a string of alphanumeric characters corresponding to a generic emotion icon thereof (for example, the alphanumeric string “:)” for the set of smiles). When the user enters the alphanumeric string of the set in the input frame 215, this alphanumeric string is automatically converted into the graphic representation of the first corresponding emotion icon (with the lowest intensity) by the auto-composition function. If the user repeats the last character of the alphanumeric string, the emotion icon is replaced with the next one in the set (with increasing intensity), with the process that is reiterated at every repetition of the last character of the alphanumeric string (according to a wrap-around list). For example, by inserting the character “:” followed of the character “)” the emotion icon of the slight smile appears (denoted with 240a). By repeating the character “)” this emotion icon 240a is replaced with the emotion icon of the more intense smile (240b), which is shown next to it in the figure for the sake of display convenience; by continuing entering the character “)” the emotion icon 240b becomes the emotion icon of a very intense smile (240c). The emotion icons 240a-240b are restored in the reverse order at every deletion of the last inserted alphanumeric character (by the key “<---”).

As above, the same result can also be obtained by maintaining pressed the key corresponding to the last character of the alphanumeric string (i.e., the key “)” in the example at issue), with the addition of a restore command (in the command bar). Preferably, the desired effect is again obtained by changing the emotion icons 240a-240c gradually (for example, by means of the “morphing” technique).

The proposed feature allows conveying different intensities of the selected emotional condition in a simple and clear manner.

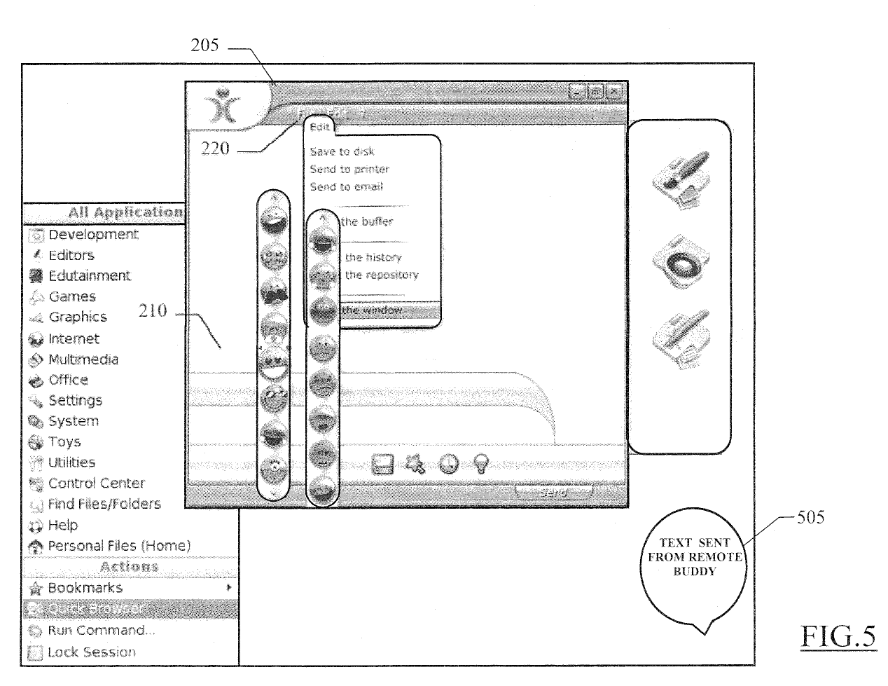

With regards now to FIG. 4a, it is also possible to resize the emotion icons dynamically. Particularly, the user pre-selects a particular emotion icon by stopping the pointer over it. If the user now scrolls a central wheel of the mouse backwards, the pre-selected emotion icon (denoted with 240l) is made smaller.

On the contrary, as shown in FIG. 4b, by scrolling the same wheel of the mouse forwards, the emotion icon (now denoted with 240h) is made bigger. Preferably, a restore command is also available (for example, selected by a contextual menu that is open with the right button of the mouse), which restore command allows restoring the pre-selected emotion icon to its standard size. Passing to FIG. 4c, in any case the user can then select the emotion icon so resized, i.e., smaller (240l) or bigger (240h), by a double click, so as to insert it in the desired position of the input frame 215.

The feature described above provides a functionality of zoom in real time of the emotion icons. For example, this allows adapting the emotion icons to the type of font used in the message, or to associate intensity with the meaning of the emotion icons (i.e., more intense as their sizes increase).

Besides, if the user writes (in the input frame 215) the alphanumeric string of the desired emotion icon directly, this emotion icon is generally inserted by the auto-composition function in a smaller size than the ones supported by the respective panel; in this way, it is possible to discriminate the input mode of the different emotion icons (i.e., by the direct selection or the auto-composition) according to their sizes.

Considering now FIG. 5, another supported feature is the possibility of inserting animated icons in the message (for example, by a suitable command of the bar 220). Particularly, this command opens another panel wherein it is possible to select a desired figure (such as a small balloon, a cloud, a plane and the like); the user can then enter a desired text in the selected figure. Consequently, when the message (once sent) is shown in the output frame 210, there will appear an animated icon 505 formed by the desired figure with the inserted text within it. The desired icon 505 moves throughout the whole working area (desktop) of the screen of the computer; for example, the animated icon 505 crosses the screen from the left to the right (coming out from a right edge of the screen to reappear continuously from its left edge).

In this way, it is possible to send messages that immediately catch the other users' attention.

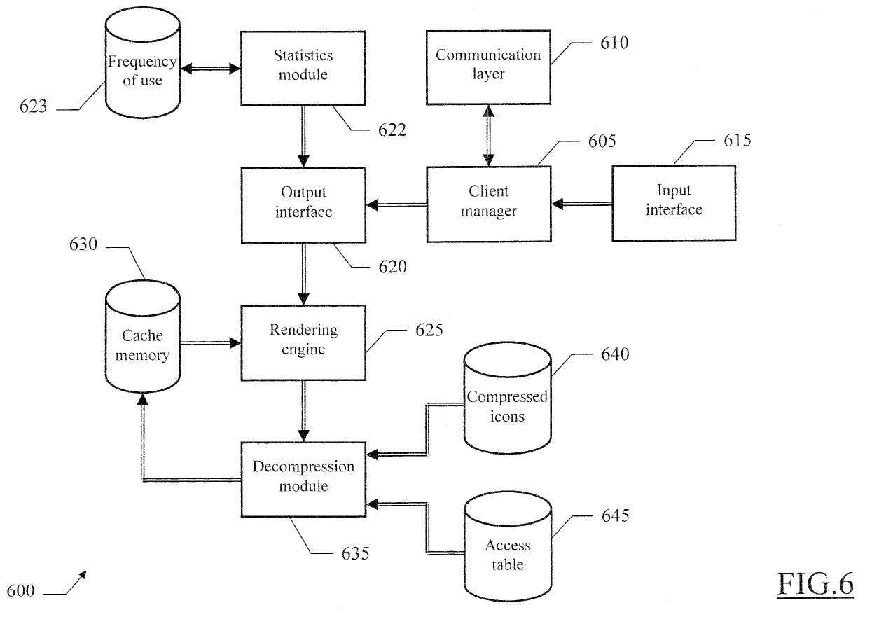

With regards now to FIG. 6, the main software components running on the computer of every user are denoted as a whole with the reference 600. The information (programs and data) is typically stored on the hard disk and loaded (at least partially) into the working memory of the computer when the programs are running, together with an operating system and other application programs (not shown in the figure). The programs are initially installed onto the hard disk, for example, from CD-ROM.

The access to the chat requires the installation (on the computer) of a client manager 605, which controls every section established with the respective server. For this purpose, the client manager 605 interfaces with a communication layer 610 (for sending new messages to the server and for receiving the messages inserted in every rooms from the server). The client manager 605 receives information (commands and data) from an input interface 615, through two drivers for the keyboard and the mouse.

The client manager 605 controls an output interface 620, which drives the monitor (through a corresponding driver). The output interface 620 exploits a statistics module 622. The statistics module 622 manages a table 623, which stores the frequency of use of every emotion icon; for example, this frequency of use is calculated according to the number of selections in a preceding period, either predetermined (such as 10-20 minutes) or defined by a specific event (such as the beginning of the session). Besides, the table 623 also contains the instant of the last selection of every emotion icon (if available).

The output interface drives a rendering engine 625 for the representation of the different graphic elements associated with the window of every room (and in particular the category icons, the emotion icons, and the animated icons). For this purpose, the rendering engine 625 accesses a cache memory 630 of the direct access type, where there are stored the digital representations of the icons being used recently (for example, 5-10). Every digital representation consists of a map of values (bitmap), each one representing a corresponding basic element (pixel) of the icon. Preferably, in order to obtain a high graphic quality (especially when the icons are resized), the bitmaps are generated by applying digital filters to the source of the information (for example, based on the algorithm Lanczos3 or an algorithm derived therefrom).

Whenever an icon must be displayed, the rendering engine 625 verifies if its bitmap is present in the cache memory 630. In the affirmative case (hit), the bitmap of the desired icon is extracted from the cache memory 630 for its display. On the contrary (miss), the rendering engine requires the bitmap of the desired icon to a decompression module 635. The decompression module 635 accesses a file 640 where the digital representations of all the icons are stored; this information is saved in a compressed form (for example, by using an algorithm “zlib deflate”). Particularly, the file of the compressed icons 640 consists of a matrix formed by the bitmaps of all the icons; the bitmap of every icon is identified by the coordinates of an upper left edge and a lower right edge inside the matrix. The coordinates of the bitmaps of all the icons are stored in a table 645 of the associative access type (which is read by the decompression module 635). In response to the request of a specific icon (received from the rendering engine 625), the decompression module 635 retrieves the coordinates of its bitmap from the access table 645; this information is then used to extract the desired bitmap from the compressed icon file 640. The bitmap so obtained is then decompressed and inserted into the cache memory 630. For this purpose, it is in general necessary to evict a location of the cache memory 630; the location to be evicted is selected according to a suitable replacing algorithm, for example, of the “Least Recently Used, or LRU” type.

In this manner, for the same memory space being used, it is possible to load a far higher amount of information for every icon (without any negative effect on the display speed). For example, let us consider a typical situation with 200 icons, each one requiring 512 k bytes for its bitmap. In this case, in the solutions known in the art it would be necessary 200*512 k=20M byte of memory for the representation of all the icons. On the contrary, in the solution described above the same result can be obtained with only 1M byte of memory (for the compressed images and the cache memory).

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a matter of general design choice.

For example, similar considerations apply if the chat is implemented in a system with a different architecture (for example, based on a LAN); besides, every computer may have another structure or include similar elements; in any case, it is possible to replace the computer with any code execution entity (such as a PDA, a mobile phone, and the like).

It is evident that the emotion icons, the categories, the category icons and the animated icons described above are merely illustrative. For example, the concepts of the present invention also apply to emotion icons that represent music, a corporal position (also known as “orz” icons), a flag of text, and the like.

Alternatively, different commands can be provided to change the sizes of the emotion icons (for example, by a special scroll bar).

In a different implementation, the display of every category icon is replaced with the one of the emotion icon of more common use of the corresponding category (instead of the one of the last selected emotion icon).

Besides, nothing prevents maintaining this display over time (for example, for the whole duration of the session).

Similar considerations apply if the alphanumeric strings used to insert the emotion icons are interpreted in a reverse order (from the right to the left), or in vertical (for example, through the use of dieresis).

In any case, the provision of a fixed frequency for the rotation of the emotion icons is not excluded.

The principles of the present invention are also applicable when the emotion icons of every category are grouped in whatever other set of emotion icons in some way correlated to one another.

Alternatively, the rotation of the emotion icons (in every category or set at variable intensity) can be obtained with a suitable command (for example, provided in the command bar), even only of the unidirectional type.

Similarly, the selected emotion icons can also be shaded off among different colours; however, an implementation where the selected emotion icons are highlighted by the standard XOR algorithm is possible.

Besides, the provision of different animated icons is within the scope of the invention; for example, these animated icons can have another shape, can be only of the graphic type (without any text inside them), or can move in a different manner.

Similarly, alternative algorithms are possible to replace the icons in the cache memory (for example, of the random or FIFO type).

Even if in the preceding description reference has been made to a chat, that is not to be intended as a limitation; indeed, the proposed solution can be used to send any type of messages (for example, in an instant messaging service).

Similar considerations apply if the program (which may be used to implement each embodiment of the inventions) is structured in a different way, or if additional modules or functions are provided; likewise, the memory structures may be of other types, or may be replaced with equivalent entities (not necessarily consisting of physical storage media). Moreover, the proposed solution lends itself to be implemented with an equivalent method (by using similar steps, removing some steps being not essential, or adding further optional steps—even in a different order). In any case, the program may take any form suitable to be used by or in connection with any data processing system, such as external or resident software, firmware, or microcode (either in object code or in source code). Moreover, it is possible to provide the program on any computer-usable medium; the medium can be any element suitable to contain, store, communicate, propagate, or transfer the program. For example, the medium may be of the electronic, magnetic, optical, electromagnetic, infrared, or semiconductor type; examples of such medium are fixed disks (where the program can be pre-loaded), removable disks, tapes, cards, wires, fibers, wireless connections, networks, broadcast waves, and the like.

In any case, the solution according to the present invention lends itself to be implemented with a hardware structure (for example, integrated in a chip of semiconductor material), or with a combination of software and hardware.

It is important to point out that the additional features described above are not strictly necessary; therefore it is possible to provide only some of these additional features, down to none of them.

Vice versa, the same additional features (like the possibility of resizing the emotion icons, of replacing the display of every category icon with the display of the last selected emotion icon of the category, of replacing the emotion icons of the category and/or the set at variable intensity in rotation, of inserting animated icons, of compressing the icons, or of using the cache memory) may be used, alone or in combination to one another, also without the main feature described above of the partitioning of the emotion icons into categories.

1. A method for sending messages in a data processing system (100), the method including the steps of:
providing a plurality of emotion images (240) each one including a digital graphic representation of an emotional state, the emotion images being partitioned into a plurality of categories,
providing a plurality of category images (230) each one including a digital graphic representation of an emotional category,
displaying at least part of the category images (225),
selecting one of the displayed category images (230s)
displaying at least part of the emotion images associated with the selected category image (235),
selecting one of the displayed emotion images (240s), and
inserting the selected emotion image into a new message (215).

2. The method according to claim 1, further including the steps of:
pre-selecting one of the emotion images (240l,240h),
inserting a size update command, and
updating the size of the pre-selected emotion image according to the size update command.

3. The method according to claim 2,
wherein the step of inserting the size update command includes moving a wheel of a mouse (130) in a first direction or in a second direction, and
wherein the step of updating the size includes making bigger or making smaller the pre-selected emotion image (240l,240h) in response to the moving of the wheel in the first direction or in the second direction, respectively.

4. The method according to claim 1, further including the steps for each emotional category of:
replacing the displayed category image (230) with the display of a last selected emotion image of the corresponding category.

5. The method according to claim 4, further including the step of:
restoring the replaced category image (230) after a predefined period from the selection of the last emotion image (240s).

6. The method according to claim 1, further including the steps of:
typing an alphanumeric representation of a chosen emotion image, and
inserting the chosen emotion image into the new message (215) in place of the alphanumeric representation.

7. The method according to claim 6, wherein for each emotional category the corresponding category images (240) are ordered in an emotional sequence, the method further including the steps of:
inputting a rotation command, and
replacing the chosen emotion image with an adjacent emotion image in the emotional sequence according to the rotation command.

8. The method according to claim 7, further including the steps of:
dynamically updating the emotional sequence according to a frequency of use of the emotion images (240) of the category.

9. The method according to claim 6, wherein for each emotional category the corresponding category images (240) include at least one set of correlated emotion images ordered in an intensity sequence of the corresponding emotional states, the method further including the steps of:
inputting an intensity update command, and
replacing the chosen emotion image (240a) with an adjacent emotion image (240b-240c) in the intensity sequence according to the intensity update command.

10. The method according to claim 7, wherein the alphanumeric representation of the chosen emotion image (240a) includes a string of character,
the step of inputting the rotation command or the intensity update command including repeating a last character of the string, and
the step of replacing the chosen emotion image including replacing the chosen emotion image with a next emotion image (240b-240c) in the emotional sequence or in the intensity sequence in response to each repetition of the last character.

11. The method according to claim 7, wherein the alphanumeric representation of the chosen emotion image (240a) includes a string of characters,
the step of inputting the rotation command or the intensity update command including maintaining pressed a key corresponding to a last character of the string, and
the step of replacing the chosen emotion image including replacing the chosen emotion image with a next emotion image (240b-240c) in the emotional sequence or in the intensity sequence in response to each expiration of a predetermined period with the key being pressed.

12. The method according to claim 10, further including the steps of:
inputting an inversion command, and
replacing the next emotion image (240b-240c) with a preceding emotion image (240a-240b) in the emotional sequence or in the intensity sequence in response to the inversion command.

13. The method according to claim 1, further including the step of:
continuously shading a chromatic tonality of each selected or chosen icon (240si-240sf).

14. The method according to claim 1, further including the step of:
inserting an animated image (505) into the new message, the animated image being adapted to cross a display screen (120).

15. The method according to claim 14, further including the step of:
inserting a text in the animated image (505).

16. The method according to claim 1, further including the steps of:
storing all the emotion images and category images in compressed form (640-645),
verifying the availability of the selected or chosen emotion image in a cache memory structure (630),
de-compressing the selected or chosen emotion image in the cache memory structure in response to the non-availability, and
extracting the selected or chosen emotion image from the cache memory structure.

17. The method according to claim 1, wherein the messages are messages of a chat.

18. A computer program (600) for performing the method of claim 1 when the computer program is executed on a data processing system (100).

19. A system (100) including means (600) for performing the steps of the method according to claim 1.

20. The method according to claim 2, further including the steps for each emotional category of:
replacing the displayed category image (230) with the display of a last selected emotion image of the corresponding category.
